(19) United States
(12) Patent Application Publication
(10) Pub. No.: US 2025/0320334 A1
(43) Pub. Date: Oct. 16, 2025

(54) WATER-DISPERSIBLE COPOLYAMIDE

(71) Applicant: Arkema France, Colombes (FR)

(72) Inventors: Thierry BRIFFAUD, Serquigny (FR); Joël VERGER, Serquigny (FR)

(73) Assignee: Arkema France, Colombes (FR)

(21) Appl. No.: 17/769,611

(22) PCT Filed: Oct. 16, 2020
(86) PCT No.: PCT/FR2020/051853

§ 371 Date: Apr. 15, 2022

(30) Foreign Application Priority Data
Oct. 18, 2019 (FR) FR1911710

(51) Int. Cl. C08G 69/14

(52) U.S. Cl. CPC C08G 69/14

(57) ABSTRACT

The invention is mainly directed toward a water-dispersible copolyamide comprising at least four different polyamide units, in which: at least one of said polyamide units includes at least one sulfonate group, said polyamide sulfonate unit being present in a content of at least 15% by weight; and at least two of said polyamide units are derived from aliphatic monomers, it being understood that said copolyamide includes at least 15% by weight of sulfonate monomer and does not include more than 20% by weight of caprolactam-based unit. The invention is moreover directed toward a composition comprising said water-dispersible copolyamide, notably in filament form.

### TECHNICAL FIELD

The present patent application relates to a water-dispersible copolyamide, to the process for manufacturing same and also to a composition comprising said copolyamide which is useful as a support material in 3D printing.

### PRIOR ART

In additive manufacturing, a three-dimensional object is manufactured by addition of material rather than by subtraction as in conventional forming processes.

Among the manufacturing processes that are particularly known is the FDM (fused deposition modeling) technology, in which a filament of material is deposited and melted to manufacture an article. In this process, it is generally necessary to provide a support structure when the manufactured article has overhanging parts or vacant segments.

These support structures may be constructed via the same technology. The material used, known as the support material or sacrificial material, must meet a certain number of requirements, and notably it must have good mechanical properties at the melting point of the material used for manufacturing the article, and must thus have a glass transition temperature that is higher than the melting point of the material used for manufacturing the article. Moreover, if the support material must adhere to the material used for manufacturing the article during the construction, it must be able to be readily removed from the article once the construction is complete.

Particularly appreciated support materials are those that are water-dispersible and that can be removed by simply passing through water.

For this purpose, international patent application WO 2016/205690 A1 proposes sulfopolyamides, sulfopolyesters or sulfopolyurethanes obtained by copolymerization with a sulfonated monomer, and more particularly the sodium or lithium salt of 5-sulfoisophthalic acid (5-SSIPA, CAS #6362-79-4). Said document describes two specific sulfopolyamides, 61/6T/6SSIPA and 12/MACMI/MACMSSIPA. However, it does not give any details regarding their synthesis or their properties such as their inherent viscosity or water-dispersibility. It is difficult to obtain these polymers with a molar mass that is sufficient to ensure the required mechanical properties.

Moreover, their high glass transition temperature (about 200° C.) associated with the presence of ionic groups suggests a very high melt viscosity.

Certain copolyamide sulfonates have moreover been described for other applications. Thus, international patent application WO 2011/147739 A1 describes copolyamides obtained by polycondensation of a salt of hexamethylenediamine and adipic acid with small amounts of the lithium salt of 5-sulfoisophthalic acid for their gas-barrier and liquid-barrier properties. U.S. Pat. No. 5,889,138 describes copolyamide sulfonates for improving the stain resistance of polyamide fibers. The copolyamide 66/6SSIPA specifically described has a glass transition temperature (Tg) that is too low to be used in 3D printing with the majority of materials. The water-dispersibility of these copolyamides is moreover usually insufficient for the intended application.

Moreover, patent application EP 0 696 607 A1 describes caprolactam-based copolyamide sulfonates as film-forming agents that are useful for preparing hair fixatives. Finally, French patent application FR 2 172 973 describes such copolyamide sulfonates for improving the ability of polyamide fibers to be dyed. Now, due to the incomplete polymerization of caprolactam, these copolyamides have a high content of residual monomer, cyclic dimer and higher cyclic oligomers. On account of the toxicity of these compounds, it is desired to limit the use of these copolyamides.

It is thus still sought to propose a copolyamide which is water-dispersible, which has a glass transition temperature of less than 200° C., notably less than 150° C., which has mechanical properties that are sufficient for serving as a support material and which does not produce any effluents containing toxic residues.

### SUMMARY OF THE INVENTION

Thus, according to a first aspect, one subject of the invention is a water-dispersible copolyamide comprising at least four different polyamide units, in which:
at least one of said polyamide units includes at least one sulfonate group, said polyamide sulfonate unit being present in a content of at least 15% by weight; and
at least two of said polyamide units are derived from aliphatic monomers,
   it being understood that said copolyamide does not include more than 20% by weight of caprolactam-based unit.

According to one embodiment, the water-dispersible copolyamide comprises at least five different polyamide units.

According to one embodiment, the water-dispersible copolyamide is of formula (I):

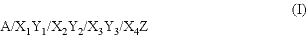

in which:
A is a unit obtained from at least one lactam or aminocarboxylic acid comprising at least 6 carbon atoms;
X₁Y₁ is a unit obtained from an aliphatic, cycloaliphatic, heterocyclic or arylaliphatic diamine X₁ and from an aliphatic or aromatic dicarboxylic acid Y₁;
X₂Y₂ is a unit obtained from an aliphatic, cycloaliphatic, heterocyclic or arylaliphatic diamine X₂ and from an aliphatic or aromatic dicarboxylic acid Y₂;
X₃Y₃ is a unit obtained from an aliphatic, cycloaliphatic, heterocyclic or arylaliphatic diamine X₃ and from an aliphatic or aromatic dicarboxylic acid Y₃; and
X₄Z is a unit obtained from an aliphatic, cycloaliphatic, heterocyclic or arylaliphatic diamine X₄ including 4 to 12 carbon atoms and a sulfonate compound Z chosen from aromatic dicarboxylic acid sulfonates, aliphatic sulfonates or esters thereof, including 4 to 18 carbon atoms and bearing at least one group of formula SO₃⁻X⁺ in which X may be a hydrogen, a quaternary ammonium group or a monovalent metal.

According to one embodiment, the copolyamide does not include more than 10% by weight of cycloaliphatic diamine residues.

According to one embodiment, the copolyamide is of formula (I), in which A is a lactam or an aminocarboxylic acid including 10 to 12 carbon atoms, respectively, notably chosen from 11-aminoundecanoic acid and lauryllactam.

According to one embodiment, the copolyamide is of formula (I) in which X₁, X₂, X₃ and X₄ are identical or different, and chosen from 1,2-ethylenediamine, 1,6-hexamethylenediamine, 1,9-nonanediamine and 1,10-decanediamine.

According to one embodiment, the copolyamide is of formula (I) in which Y₁ and Y₂ are identical or different, and chosen from adipic acid, azelaic acid, sebacic acid and dodecanedioic acid.

According to one embodiment, the copolyamide is of formula (I), in which Y₃ is isophthalic acid.

According to one embodiment, the sulfonate compound is chosen from the sodium, lithium or potassium salt of 5-sulfoisophthalic acid and the sodium, lithium or potassium salt of the methyl diester of 5-sulfoisophthalic acid.

According to one embodiment, the water-dispersible copolyamide comprises 0 to 30% by weight of unit A, 0 to 30% by weight of unit X₁Y₁, 0 to 30% by weight of unit X₂Y₂, 0 to 30% by weight of unit X₃Y₃ and 10% to 50% by weight of unit X₄Z, it being understood that said copolyamide includes at least four different polyamide units.

According to one embodiment, the water-dispersible copolyamide comprises at least 40% by weight of aromatic units.

According to one embodiment, the water-dispersible copolyamide has a glass transition temperature of between 10° and 140° C., preferably between 11° and 130° C.

According to one embodiment, the water-dispersible copolyamide has an inherent viscosity of greater than 0.4 dl/g, preferably greater than 0.5 dl/g and most particularly greater than 0.6 dl/g.

According to a second aspect, the invention is directed toward a process for manufacturing said water-dispersible copolyamide, comprising the steps of:
a. providing monomers chosen, respectively, from a lactam, an aminocarboxylic acid, and a diamine and a diacid, in suitable number and proportions;
b. polycondensation of the monomers, where appropriate, in the presence of one or more catalysts and/or chain limiters under conditions suitable for obtaining said copolyamide; and where appropriate, granulation of said copolyamide.

Finally, according to a third aspect, the invention relates to a composition comprising said water-dispersible copolyamide, notably in filament form.

### DESCRIPTION OF THE EMBODIMENTS

### Definition of the Terms

The term “copolymer” is intended to denote a polymer derived from the copolymerization of at least two chemically different types of monomer, referred to as comonomers. A copolymer is thus formed from at least two repeating units. It may also be formed from three or more repeating units. It may be any of the listed types of copolymers, notably a random copolymer or a block copolymer. It is a preferably random copolymer.

The term “polyamide” (homopolyamide or copolyamide) is intended to denote the condensation products of lactams, amino acids and/or diacids with diamines and, as a general rule, any polymer essentially formed from units or monomers linked together via amide groups. Polymers moreover including units or monomers linked together via other groups, for example via ester, urethane or urea groups, are, however, also targeted, when these units are in minor amount.

The term “polyamide monomer or units” should be taken, in the context of the present specification, in the sense of a “repeating unit”, since the case where a repeating unit of the polyamide consists of a combination of a diacid with a diamine is a special case. It is considered that it is the combination of a diamine and of a diacid, that is to say the diamine·diacid pair (in an equimolar amount), which corresponds to the monomer. The reason for this is that, individually, the diacid or the diamine is only a structural unit, which is not enough on its own to be polymerized. The polyamide units may notably be aliphatic, aromatic and/or semiaromatic.

The term “sulfonate compound” is intended to denote a compound that is capable of reacting by polycondensation including a group —SO₃X in which X may be a hydrogen, a quaternary ammonium group or a monovalent metal. Preferably, the sulfonate group is borne by a dicarboxylic acid.

The term “copolyamide” (abbreviated as CoPA) means the products of polymerization of at least two, and, in the context of the present invention, four or even five or more, notably six, seven or eight different monomers.

The term “water-dispersible” is intended to characterize a material which disintegrates in an aqueous solution free of agents which promote its disintegration or dissolution, such as bases (sodium hydroxide) or acids. In other words, it is water which disintegrates or dissolves the material. Preferably, the water then has a neutral pH, i.e. a pH of between about 5 and 9. Preferably, the material is water-dispersible not only in demineralized water, but also in a water containing various mineral salts, for instance tap water. In the course of the disintegration, the material may break down into smaller pieces and/or particles of polymer; a portion of the material may also become dissolved.

The term “inherent viscosity” denotes the viscosity as measured according to the standard ISO 307:2007 modified in that the solvent is m-cresol rather than sulfuric acid, in that the concentration is 0.5% by weight and in that the temperature is 20° C. The inherent viscosity enables the molar mass of the polymer to be evaluated.

The term “filament” denotes a thread of variable thickness, generally from 10 μm to 10 mm and preferably from 50 μm to 5 mm of meltable material optionally reinforced with fillers, which is suitable for use in a 3D printing machine, notably in the FDM technology.

The term “melting point” is intended to denote the temperature at which an at least partially crystalline polymer passes to the viscous liquid state, as measured by differential scanning calorimetry (DSC) according to the standard NF EN ISO 11 357-3 using a heating rate of 20° C./min.

The term “glass transition temperature” is intended to denote the temperature at which an at least partially amorphous polymer passes from a rubbery state to a glassy state, or vice versa, as measured by differential scanning calorimetry (DSC) according to the standard NF EN ISO 11 357-2 using a heating rate of 20° C./min.

The nomenclature used to define polyamides is described in the standard ISO 1874-1:2011 “Plastics—Polyamide (PA) molding and extrusion materials—Part 1: Designation”, notably on page 3 (tables 1 and 2), and is well known to those skilled in the art.

The term “aromatic unit” is intended to denote a polyamide unit which is derived from the polycondensation of a nonaromatic diamine with an aromatic diacid, of a diamine including an aromatic unit with a nonaromatic diacid or alternatively of a diamine including an aromatic unit and an aromatic diacid.

### [Copolyamide]

The invention proposes a water-dispersible copolyamide that is notably useful as a support material in 3D printing.

In order to be useful in this application, the material preferably has the following properties in combination:
good water-dispersibility, including in tap water and including after a prolonged period of storage;
a glass transition temperature close to that of the printed material;
at the temperature at which the 3D printing is performed:
   a mechanical strength and a stiffness that are sufficient for supporting the printed piece;
   a melt viscosity close to that of the printed material; and
after dispersion in water, the formation of an effluent which can be removed without danger.

Now, tests have revealed that a copolyamide sulfonate including two different polyamide units does not disperse in water even when it includes a high content of sulfonate monomer. Moreover, it has been observed that while passage to a terpolyamide can improve the water-dispersibility, this is not long-lasting but instead degrades markedly over time. This observation might be explained by a slight crystallization of the polyamide, which would reduce its solubility in water.

On the other hand, the Applicant has found that the addition to these terpolyamides of an additional polyamide unit, chosen such that at least two of the polyamide units of the resulting copolyamide are aliphatic, makes it possible to prepare copolyamides which meet the requirements, namely a high glass transition temperature in combination with excellent water-dispersibility in tap water at 70° C., even after conditioning for 15 days.

Moreover, the Applicant has identified the minimum content of sulfonate monomer required in the copolyamide to ensure good water-dispersibility.

According to the invention, copolyamides are thus proposed comprising at least four and preferably five different polyamide units, in which:
at least one of said polyamide units includes at least one sulfonate group; and
at least two of said polyamide units are derived from aliphatic monomers;
   it being understood that said copolyamide includes at least 15% by weight of sulfonate monomer, and does not include more than 20%, preferably not more than 15%, more preferably not more than 10% and in particular not more than 5% by weight of caprolactam-based units.

Advantageously, the copolyamide is of formula (I):

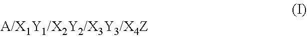

in which:
A is a unit obtained from at least one lactam or aminocarboxylic acid comprising at least 6 carbon atoms;
X₁Y₁ is a unit obtained from an aliphatic, cycloaliphatic, heterocyclic or arylaliphatic diamine X₁ and from an aliphatic or aromatic dicarboxylic acid Y₁;
X₂Y₂ is a unit obtained from an aliphatic, cycloaliphatic, heterocyclic or arylaliphatic diamine X₂ and from an aliphatic or aromatic dicarboxylic acid Y₂;
X₃Y₃ is a unit obtained from an aliphatic, cycloaliphatic, heterocyclic or arylaliphatic diamine X₃ and from an aliphatic or aromatic dicarboxylic acid Y₃; and
X₄Z is a unit obtained from an aliphatic, cycloaliphatic, heterocyclic or arylaliphatic diamine X₄ including 4 to 12 carbon atoms and a sulfonate compound Z chosen from aromatic dicarboxylic acid sulfonates, aliphatic sulfonates or esters thereof, including 4 to 18 carbon atoms and bearing at least one group of formula SO₃⁻X⁺ in which X may be a hydrogen, a quaternary ammonium group or a monovalent metal.

According to the invention, at least two of the polyamide units of the copolyamide are aliphatic. When Z is derived from an aromatic dicarboxylic acid, the unit X₄Y is not aliphatic. Also, at least two of the polyamide units A, X₁Y₁, X₂Y₂ and X₃Y₃ of the copolymer of formula (I) will then be aliphatic. When the unit A is obtained from a lactam, said lactam may be chosen from caprolactam, oenantholactam, caprylolactam, pelargolactam, decanolactam, undecanolactam and lauryllactam, in particular lauryllactam.

When the unit A is obtained from the polycondensation of an amino acid, it may be chosen from 9-aminononanoic acid, 10-aminodecanoic acid, 10-aminoundecanoic acid, 12-aminoundecanoic acid and 11-aminododecanoic acid and derivatives thereof, notably N-heptyl-11-aminoundecanoic acid, in particular 11-aminoundecanoic acid.

However, it is preferred to avoid the use of caprolactam since said compound polymerizes incompletely and is toxic.

Advantageously, the unit A is obtained from at least one lactam or aminocarboxylic acid comprising at least 7, preferably at least 8, in particular at least 9, most particularly at least 10, notably 11 and preferably at least 12 carbon atoms.

Preferably, A is derived from a lactam or an aminocarboxylic acid including 10 to 12 carbon atoms. Among these monomers, aminoundecanoic acid and lactam 12 are particularly preferred. Preferably, the unit A is an aliphatic unit.

The diamine from which the group X₁, X₂, X₃ and X₄, respectively, is derived may be an identical or different aliphatic, cycloaliphatic, heterocyclic or arylaliphatic diamine.

Preferably, the diamine includes, independently of each other, respectively 2 to 18, preferably 4 to 12 and most particularly 6 to 10 carbon atoms.

Advantageously, the diamine is chosen from linear aliphatic diamines, notably from 1,2-ethylenediamine, 1,3-propylenediamine, 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine. Preferably, the diamine X₁, X₂, X₃ and X₄ is chosen from 1,2-ethylenediamine, 1,6-hexamethylenediamine, 1,7-heptanediamine, 1,8-octanediamine, 1,9-nonanediamine, 1,10-decanediamine, 1,11-undecanediamine and 1,12-dodecanediamine. Most particularly, the diamine X₁, X₂, X₃ and X₄ may be chosen from 1,2-ethylenediamine, 1,6-hexamethylenediamine, 1,9-nonamethylenediamine and 1,10-decamethylenediamine.

The diamine may also be chosen from branched aliphatic diamines, for example from 2,2,4-trimethyl-1,6-hexamethylenediamine and 2-methyl-1,5-pentamethylenediamine.

The diamine may also be chosen from cycloaliphatic diamines, in particular from isophoronediamine (IPD), bis(3-methyl-4-aminocyclohexyl)methane (MACM), and 2,2-bis(3-methyl-4-aminocyclohexyl)propane (MACP), and p-bis(aminocyclohexyl)methane (PACM), and 2,6-bis(aminomethyl)norbornane (BAMN), and 1,3 bis(aminomethyl)cyclohexane (1,3-BAC) and 1,4 bis(aminomethyl)cyclohexane (1,4-BAC).

Moreover, at least certain diamines X₁, X₂, X₃ or X₄ may be arylaliphatic diamines, and may be chosen from meta-xylylenediamine (MXD) and para-xylylenediamine (PXD).

Finally, at least certain diamines X₁, X₂, X₃ or X₄ may be heterocyclic diamines, and may be chosen from piperazine (Pip) and N-aminoethylpiperazine (AEP).

The dicarboxylic acid from which the group Y₁ is derived may notably be an aliphatic diacid including 6 to 18, preferably 6 to 12 and most particularly 8 to 10 carbon atoms. It is preferably a a linear dicarboxylic acid. Advantageously, it is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid. Preferably, Y₁ is chosen from adipic acid, azelaic acid, sebacic acid and dodecanedioic acid.

The dicarboxylic acid from which the groups Y₂ and Y₃ are derived is an aliphatic or aromatic dicarboxylic acid which may be identical or different. Preferably, the diacid Y₂ and Y₃ includes, independently of each other, respectively 6 to 18, preferably 6 to 12 and most particularly 8 to 10 carbon atoms. When it is an aliphatic dicarboxylic acid, it may be chosen from the list mentioned previously for the dicarboxylic acid Y₁. Advantageously, it may be chosen from adipic acid, sebacic acid and dodecanedioic acid. When it is an aromatic acid, it may notably be chosen from terephthalic acid, 2,6-naphthalenedicarboxylic acid and isophthalic acid, isophthalic acid being preferred. According to one embodiment, Y₁ and Y₂ are chosen from adipic acid, azelaic acid, sebacic acid and dodecanedioic acid. According to one embodiment, Y₃ is isophthalic acid.

The polyamide unit X₁Y₁ is preferably chosen from PA 26, PA 29, PA 210, PA 212, PA 66, PA 69, PA 610, PA 612, PA 96, PA 99, PA 910, PA 912, PA 106, PA 109, PA 1010, PA 1012, PA 21, PA 61, PA 91 and PA 101.

The polyamide unit X₂Y₂ is preferably chosen from PA 26, PA 29, PA 210, PA 212, PA 66, PA 69, PA 610, PA 612, PA 96, PA 99, PA 910, PA 912, PA 106, PA 109, PA 1010, PA 1012, PA 21, PA 61, PA 91 and PA 101.

The polyamide unit X₃Y₃ is preferably chosen from PA 26, PA 29, PA 210, PA 212, PA 66, PA 69, PA 610, PA 612, PA 96, PA99, PA 910, PA 912, PA 106, PA 109, PA 1010, PA 1012, PA 21, PA 61, PA 91 and PA 101, PA 2T, PA 6T, PA 9T and PA 10T.

The sulfonate monomer is preferably derived from a dicarboxylic acid or an ester thereof bearing at least one sulfonate acid group and a diamine. Preferably, the dicarboxylic acid or ester sulfonate is used in the form of an alkali metal (notably sodium, lithium or potassium), alkaline-earth metal or quaternary ammonium sulfonate. The dicarboxylic acid or ester sulfonate moreover bears two acid or ester functions attached to one or more aromatic rings, when they are aromatic dicarboxylic acids, or to the aliphatic chain, when they are aliphatic dicarboxylic acids.

Among the suitable sulfonate compounds, mention may be made of aromatic dicarboxylic acid or anhydride sulfonates such as sulfoisophthalic, sulfoterephthalic or sulfo-orthophthalic acids or anhydrides, sulfo-4-naphthalene-2,7-dicarboxylic acids or anhydrides, and also aliphatic dicarboxylic acid or anhydride sulfonates such as sulfosuccinic diacids or anhydrides or lower diesters (methyl, ethyl, propyl, isopropyl, butyl) thereof.

The preferential sulfonate compounds are the sodium, lithium or potassium salts of sulfoisophthalic and sulfosuccinic acids or anhydrides and the methyl diester thereof. Preferably, the sulfonate compound is the lithium salt of 5-sulfoisophthalic acid (abbreviated as LiSIPA), the sodium salt of 5-sulfoisophthalic acid (abbreviated as SSIPA hereinbelow), the potassium salt of 5-sulfoisophthalic acid (abbreviated as KSIPA) or the methyl diester thereof (abbreviated as LiSIPMe, SSIPMe and KSIPMe, respectively).

The unit X₄Z is preferably chosen from 2SSIPA, 6SSIPA, 9SSIPA, 10SSIPA, 2LiSIPA, 6LiSIPA, 9LiSIPA, 10LiSIPA, 2KSIPA, 6KSIPA, 9KSIPA, 10KSIPA, 2SSIPMe, 6SSIPMe, 9SSIPMe, 10SSIPMe, 2LiSIPMe, 6LiSIPMe, 9LiSIPMe, 10LiSIPMe, 2KSIPMe, 6KSIPMe, 9KSIPMe and 10KSIPMe. 2SSIPA, 6SSIPA, 6LiSIPA and 6SSIPMe are particularly preferred.

Where appropriate, the water-dispersible copolyamide according to the invention may also include the monomers indicated in formula (I) of other additional monomers. In particular, it may include one, two or more additional monomers X, Y, as defined above. Moreover, the copolyamide may include other non-polyamide monomers.

The copolyamide according to the invention may include two, three, four or five aliphatic polyamide units. Preferably, it includes two or three aliphatic polyamide units.

The weight ratio between the various polyamide units in the copolyamide may vary widely. However, in order for its glass transition temperature to be sufficiently high, i.e. preferably greater than 100° C., it is preferable for the copolyamide to include a mass content of aromatic units of greater than 40%, preferably greater than 45% and most particularly greater than 50% by weight. Moreover, in order to ensure satisfactory water-dispersibility, the mass content of sulfonate monomer in the copolyamide is at least 20%, preferably at least 25%, advantageously at least 30%, in particular at least 35% relative to the weight of all of the monomers.

Advantageously, the mass content of sulfonate monomer in the copolyamide is from 15% to 70%, in particular 20% to 60%, notably 20% to 50%, preferably from 25% to 40%, more preferably from 25% to 35%, relative to the weight of all of the monomers.

Moreover, the copolyamide preferably includes a low mass proportion, preferably not more than 10%, not more than 9%, not more than 8%, not more than 7%, not more than 6%, not more than 5%, not more than 4%, not more than 3%, not more than 2%, not more than 1%, or no polyamide units derived from cycloaliphatic diamines.

According to one embodiment, the copolyamide comprises from 0 to 30%, in particular from 5% to 25% and most particularly from 10% to 20% by weight of unit A, from 0 to 30%, in particular from 5% to 25% and most particularly from 10% to 20% by weight of unit X₁Y₁, 0 to 30%, in particular from 5% to 25% and most particularly from 10% to 20% by weight of the unit X₂Y₂, 0 to 30%, in particular from 5% to 25% and most particularly from 10% to 20% by weight of unit X₃Y₃ and 15% to 70%, in particular 20% to 50%, in particular from 25% to 45% and most particularly from 25% to 35% by weight of unit X₄Z, it being understood that said copolyamide includes at least four different polyamide units.

It has not been observed that an excess of carboxylic acid group or of amine group at the end of the copolyamide chain is disruptive as regards the water-dispersibility. Nevertheless, it is preferable for the copolyamide to bear chain-end carboxylic acid and amine groups in substantially equivalent amount.

According to one embodiment, the length and the chain-end functionality of the copolyamide according to the invention is modified by adding at least one suitable monofunctional or difunctional chain limiter.

Such a suitable chain limiter may notably be a linear aliphatic C2-C18 monocarboxylic acid and/or a linear aliphatic C4-C18 monoamine. It may also be a linear aliphatic C3-C36 dicarboxylic acid or a linear aliphatic C4-C18 diamine.

The acid used as chain limiter may be chosen, for example, from acetic acid, lauric acid, stearic acid, adipic acid, azelaic acid, sebacic acid and dodecanedioic acid.

Preferably, the copolyamide according to the invention is limited by a linear aliphatic C2-C18 monocarboxylic acid and/or a linear aliphatic C6-C12 dicarboxylic acid, and particularly preferably by a linear aliphatic C6-C12 dicarboxylic acid, adipic acid, sebacic acid and dodecanedioic acid being particularly preferred.

The amine used as chain limiter may be chosen, for example, from laurylamine, hexanediamine and decanediamine.

Preferably, the copolyamide according to the invention is limited by a C6-C12 monoamine and/or a C6-C12 diamine, hexanediamine and laurylamine being particularly preferred.

The chain limiter(s) are generally added in a markedly smaller amount than the monomers. Generally, their content in the monomer mixture is less than 1% by weight, preferably less than 0.5% by weight or even less than 0.2% by weight, relative to the weight of the monomer mixture.

In order to ensure sufficient mechanical strength, the copolyamide according to the invention preferably has an inherent viscosity of greater than 0.4 dl/g, preferably greater than 0.5 dl/g and most particularly greater than 0.6 dl/g.

According to one embodiment, the copolyamide has a glass transition temperature of between 10° and 140° C., preferably between 11° and 130° C. A copolyamide with a higher transition temperature has the risk of having a low molar weight due to the high viscosity of these copolyamides, and consequently of having unsatisfactory mechanical properties.

### [Process for Manufacturing the Copolyamide]

According to a second aspect, the invention is directed toward a process for preparing the described copolyamide.

In general, the process for manufacturing a water-dispersible copolyamide comprises the steps of:
a. providing monomers chosen, respectively, from a lactam, an aminocarboxylic acid, and a diamine and a diacid, in suitable number and proportions;
b. polycondensation of the monomers, where appropriate, in the presence of one or more catalysts and/or chain limiters under conditions suitable for obtaining said copolyamide; and
c. where appropriate, granulation of said copolyamide.

The copolyamide described may be obtained via any of the polycondensation processes known to those skilled in the art and described notably in the Nylon Plastics Handbook, Ed. Melvin I. Kohan, Hanser Publishers 1995 pages 17 to 27.

For example, in one embodiment, the polycondensation is performed in a single step in the same reactor at a temperature from 200 to 300° C., in particular above the melting point of the copolyamide sulfonate, at a pressure which may rise up to 30 bar and gradually reduced down to a pressure less than or equal to atmospheric pressure so as to complete the polymerization. The reaction temperature in this polycondensation step is preferably higher than the melting point of the copolyamide in order for the stirring to be effective.

The catalyst may notably be a phosphorus-based acid such as phosphoric acid and/or phosphorous acid, hypophosphorous acid and the sodium or potassium salts of these acids. The chain limiter(s) may notably be chosen from those mentioned above.

The reaction thus produces as oligomers as intermediates, which, by condensation with each other, lead directly to the polyamide in the same reactor. Optionally, the polymer may be removed from the reactor at a pressure above atmospheric pressure. The polymerization may then be optionally completed by a step of extrusion at a temperature above the melting point, or by a step of heating at a temperature below the melting point of the polyamide according to a “solid-state polymerization” process.

Alternatively, the polycondensation step is performed in three steps and comprises the following steps:
(i) a first step of pre-polymerization in a first reactor, by heating the comonomers at a temperature of from 200° C. to 300° C., notably at a pressure of from 20 to 30 bar, to obtain a prepolymer, the temperature preferably being a temperature above the melting point of the prepolymer;
(ii) a second step of transfer of the prepolymer from the first reactor to a second reactor at a temperature of from 220 to 280° C. at a pressure of from 2 to 30 bar;
(iii) a third step of polymerization by heating at a temperature of from 200 to 300° C. at a pressure which may range up to 30 bar, gradually reduced down to a pressure less than or equal to atmospheric pressure so as to complete the polymerization to obtain the copolyamide, the temperature notably being a temperature above the melting point of the copolyamide.

Optionally, the polymer after completion of the polymerization in step c. may be removed from the second reactor at a pressure above atmospheric pressure.

The polymerization may be completed by a step of extrusion at a temperature above the melting point, or by a step of heating at a temperature below the melting point of the polyamide according to a “solid-state polymerization” process.

Advantageously, the copolyamide sulfonate is subsequently recovered by cooling without direct contact with water.

### [Composition Comprising the Copolyamide]

According to a third aspect, the invention is directed toward a composition comprising the copolyamide as described above. Such a formulation may notably result from the addition of the usual additives and/or fillers to the polymer formulation.

Thus, the composition may comprise 0 to 10% by weight, preferably 1% to 8% and in particular 2% to 5% by weight of one or more from among the usual additives, such as coloring agents, pigments, dyes, anti-UV agents, antiaging agents, antioxidants, fluidizers, antiabrasion agents, mold-release agents, stabilizers, plasticizers, surfactants, optical brighteners or waxes. Moreover, the composition may include, where appropriate, fillers or reinforcers.

The copolyamide alone or formulated as described above may subsequently be formed into a shape suitable for its use. When the copolyamide is used in 3D printing, it may notably be formed into a filament, for example by extrusion.

### [Use of the Copolyamide]

According to a fourth aspect, the invention is directed toward the use of the copolyamide described in 3D printing, notably as a support material.

Specifically, the copolyamide described has excellent water-dispersibility in water, including tap water, and even after a prolonged period of storage, and also a glass transition temperature which affords it sufficient mechanical strength at the polyamide transformation temperature, for example. Advantageously, the copolyamide may be dispersed in tap water.

In order to obtain rapid dispersion, the copolyamide is preferably dispersed in hot water. Preferably, the temperature of the water used for dispersing the copolyamide is from 40 to 90° C., preferably from 50 to 80° C. and in particular from 60 to 80° C.

The invention will be explained in greater detail in the examples that follow. Unless otherwise mentioned, the percentages are weight percentages relative to the weight of the final composition.

### EXAMPLES

### Example 1

9.00 g of aminoundecanoic acid, 18.55 g of hexamethylenediamine, 7.06 g of isophthalic acid, 5.01 g of adipic acid, 5.72 g of sebacic acid, 14.66 g of the sodium salt of 5-sulfoisophthalic acid, 0.14 g of phosphoric acid at 8.5% in water, 0.08 g of sodium hypophosphite at 60% in water and 18 g of deionized water are placed in a tubular glass reactor equipped with a stirring anchor. After purging the reactor with nitrogen, the contents are heated under a stream of nitrogen over 30 minutes up to 145° C. After maintaining these conditions for 30 minutes with stirring at 50 rpm, the temperature is gradually raised over 20 minutes to 245° C. The medium is then placed under a vacuum of 50 mbar. The polymerization progress is monitored by means of a torque-meter on the stirring axle. After 140 minutes under these conditions, the tubular reactor containing the polymer obtained is cooled with ambient air.

The copolyamide obtained, having the composition indicated in table 2, is then milled in the form of granules a few mm in size and then characterized as regards its glass transition temperature, its water-dispersibility, its melt viscosity index (MVI) and its inherent viscosity, which are respectively evaluated as follows.

Glass transition temperature: measured by differential scanning calorimetry (DSC) according to the standard NF EN ISO 11 357-2 using a heating rate of 20° C./min.

Water-dispersibility: evaluated by introducing 0.5 g of copolyamide into a suitable vessel equipped with a stirrer, containing 150 g of tap water brought to a temperature of 70° C. The evaluation is performed once immediately after synthesis and once after 15 days of conditioning (at 23° C., 50% RH). The water-dispersibility is evaluated by visual examination for 10 minutes of the appearance of the dispersion obtained to classify it in one of the categories presented in table 1 below.

TABLE 1
Grid for evaluating the water-dispersibility:

| Appearance of the dispersion | Evaluation |
|---|---|
| Total dispersion, no insoluble matter | + |
| Relatively good dispersion, but insoluble | ∘ |
| matter remains in the form of small particles | |
| Poor dispersion: the copolyamide swells but | − |
| is not dispersed | |

MVI: evaluated at 220° C. under a load of 5 kg according to the standard ISO 1133-1 (2011)

Inherent viscosity: evaluated by applying the standard ISO 307:2007 modified in that the solvent is m-cresol rather than sulfuric acid, in that the concentration is 0.5% by weight and in that the temperature is 20° C.

The results are collated in table 3 below.

### Example 2

9.00 g of aminoundecanoic acid, 18.55 g of hexamethylenediamine, 7.06 g of isophthalic acid, 5.01 g of adipic acid, 5.72 g of sebacic acid, 13.77 g of the lithium salt of 5-sulfoisophthalic acid, 0.14 g of phosphoric acid at 8.5% in water, 0.08 g of sodium hypophosphite at 60% in water and 18 g of deionized water are placed in a tubular glass reactor equipped with a stirring anchor. After purging the reactor with nitrogen, the contents are heated under a stream of nitrogen over 30 minutes up to 145° C. After maintaining these conditions for 30 minutes with stirring at 50 rpm, the temperature is gradually raised over 20 minutes to 245° C. The medium is then placed under a vacuum of 50 mbar. The polymerization progress is monitored by means of a torque-meter on the stirring axle. After 41 minutes under these conditions, the tubular reactor containing the polymer obtained is cooled with ambient air.

The copolyamide obtained, having the composition indicated in table 2, is then milled in the form of granules a few mm in size and then characterized as regards its glass transition temperature, its water-dispersibility, its melt viscosity index (MVI) and its inherent viscosity, as explained in example 1. The results are collated in table 3 below.

### Example 3

9.00 g of aminoundecanoic acid, 18.55 g of hexamethylenediamine, 7.06 g of isophthalic acid, 5.01 g of adipic acid, 5.72 g of sebacic acid, 16.18 g of the sodium salt of the methyl diester of 5-sulfoisophthalic acid, 0.14 g of phosphoric acid at 8.5% in water, 0.08 g of sodium hypophosphite at 60% in water and 18 g of deionized water are placed in a tubular glass reactor equipped with a stirring anchor. After purging the reactor with nitrogen, the contents are heated under a stream of nitrogen over 30 minutes up to 145° C. After maintaining these conditions for 30 minutes with stirring at 50 rpm, the temperature is gradually raised over 20 minutes to 245° C. The medium is then placed under a vacuum of 50 mbar. The polymerization progress is monitored by means of a torque-meter on the stirring axle. After 30 minutes under these conditions, the tubular reactor containing the polymer obtained is cooled with ambient air.

The copolyamide obtained, having the composition indicated in table 2, is then milled in the form of granules a few mm in size and then characterized as regards its glass transition temperature, its water-dispersibility, its melt viscosity index (MVI) and its inherent viscosity, as explained in example 1. The results are collated in table 3 below.

### Example a (Comparative Example)

22.78 g of hexamethylenediamine, 18.38 g of adipic acid, 18.84 g of the sodium salt of 5-sulfoisophthalic acid, 0.14 g of phosphoric acid at 8.5% in water, 0.08 g of sodium hypophosphite at 60% in water and 18 g of deionized water are placed in a tubular glass reactor equipped with a stirring anchor. After purging the reactor with nitrogen, the contents are heated under a stream of nitrogen over 30 minutes up to 145° C. After maintaining these conditions for 30 minutes with stirring at 50 rpm, the temperature is gradually raised over 20 minutes to 245° C. The medium is then placed under a vacuum of 50 mbar. The polymerization progress is monitored by means of a torque-meter on the stirring axle. After 120 minutes under these conditions, the tubular reactor containing the polymer obtained is cooled.

The copolyamide obtained, having the composition indicated in table 2, is then milled in the form of granules a few mm in size and then characterized as regards its glass transition temperature, its water-dispersibility, its melt viscosity index (MVI) and its inherent viscosity, as explained in example 1. The results are collated in table 3 below.

### Example B (Comparative Example)

23.35 g of hexamethylenediamine, 5.29 g of isophthalic acid, 16.71 g of adipic acid, 14.65 g of the sodium salt of 5-sulfoisophthalic acid, 0.14 g of phosphoric acid at 8.5% in water, 0.08 g of sodium hypophosphite at 60% in water and 18 g of deionized water are placed in a tubular glass reactor equipped with a stirring anchor. After purging the reactor with nitrogen, the contents are heated under a stream of nitrogen over 30 minutes up to 145° C. After maintaining these conditions for 30 minutes with stirring at 50 rpm, the temperature is gradually raised over 20 minutes to 245° C. The medium is then placed under a vacuum of 50 mbar. The polymerization progress is monitored by means of a torque-meter on the stirring axle. After 130 minutes under these conditions, the tubular reactor containing the polymer obtained is cooled.

The copolyamide obtained, having the composition indicated in table 2, is then milled in the form of granules a few mm in size and then characterized as regards its glass transition temperature, its water-dispersibility, its melt viscosity index (MVI) and its inherent viscosity, as explained in example 1. The results are collated in table 3 below.

### Example C (Comparative Example)

9.00 g of aminoundecanoic acid, 19.7 g of hexamethylenediamine, 13.24 g of isophthalic acid, 5.01 g of adipic acid, 5.72 g of sebacic acid, 7.33 g of the sodium salt of 5-sulfoisophthalic acid, 0.14 g of phosphoric acid at 8.5% in water, 0.08 g of sodium hypophosphite at 60% in water and 18 g of deionized water are placed in a tubular glass reactor equipped with a stirring anchor. After purging the reactor with nitrogen, the contents are heated under a stream of nitrogen over 30 minutes up to 145° C. After maintaining these conditions for 30 minutes with stirring at 50 rpm, the temperature is gradually raised over 20 minutes to 245° C. The medium is then placed under a vacuum of 50 mbar. The polymerization progress is monitored by means of a torque-meter on the stirring axle. After 35 minutes under these conditions, the tubular reactor containing the polymer obtained is cooled with ambient air.

The copolyamide obtained is then milled in the form of granules a few mm in size and then characterized as regards its glass transition temperature, its water-dispersibility, its melt viscosity index (MVI) and its inherent viscosity, which are respectively evaluated as follows.

The copolyamide obtained, having the composition indicated in table 2, is milled and characterized as regards its glass transition temperature, its water-dispersibility, its viscosity index and its viscosity, as explained in example 1. The results are collated in table 3 below.

### Example D (Comparative Example)

24.00 g of aminoundecanoic acid, 13.17 g of hexamethylenediamine, 12.36 g of isophthalic acid, 10.47 g of the sodium salt of 5-sulfoisophthalic acid, 0.14 g of phosphoric acid at 8.5% in water, 0.08 g of sodium hypophosphite at 60% in water and 18 g of deionized water are placed in a tubular glass reactor equipped with a stirring anchor. After purging the reactor with nitrogen, the contents are heated under a stream of nitrogen over 30 minutes up to 145° C. After maintaining these conditions for 30 minutes with stirring at 50 rpm, the temperature is gradually raised over 20 minutes to 245° C. The medium is then placed under a vacuum of 50 mbar. The polymerization progress is monitored by means of a torque-meter on the stirring axle. After 140 minutes under these conditions, the tubular reactor containing the polymer obtained is cooled.

The copolyamide obtained, having the composition indicated in table 2, is then milled in the form of granules a few mm in size and then characterized as regards its glass transition temperature, its water-dispersibility, its melt viscosity index (MVI) and its inherent viscosity, as explained in example 1. The results are collated in table 3 below.

TABLE 2
Composition of the copolyamides synthesized

| | | | Weight % of |
|---|---|---|---|
| | | Weight ratio between | sulfonate |
| Example | Formula | monomers [%]) | compound |
| 1 | 11/610/66/6I/6SSIPA | 15/15/15/20/35 | 24.4 |
| 2 | 11/610/66/6I/6LiSIPA | 15/15/15/20/35 | 23.3 |
| 3 | 11/610/66/6I/6SSIPMe | 15/15/15/20/35 | 26.0 |
| A | 66/6SSIPA | 55/45 | 31.4 |
| B | 66/6I/6SSIPA | 50/15/35 | 24.4 |
| C | 11/610/66/6I/6SSIPA | 15/15/15/37.5/17.5 | 12.2 |
| D | 11/6I/6SSIPA | 40/35/25 | 17.4 |

TABLE 3
Properties of the copolyamides synthesized

| | | | | Water-dispersibility | |
|---|---|---|---|---|---|
| | | MVR at | Inherent | After | After |
| Ex. | Tg [° C.] | 220° C./5 kg | viscosity | synthesis | conditioning * |
| 1 | 115 | 5.4 | 0.44 | + | + |
| 2 | 128 | ND | ND | + | + |
| 3 | 123 | ND | ND | + | + |
| A | 114 | 2.8 | ND | − | − |
| B | 114 | 5.0 | 0.5 | ∘ | − |
| C | 102 | ND | ND | ∘ | − |
| D | 103 | 6.2 | 0.6 | − | − |

* 15 days at 23° C., 50% RH

The set of tests shows that a copolyamide bearing two polyamide units does not disperse in water even when it includes a high content of sulfonate monomer (see comparative example A). Moreover, while passage to a terpolyamide can improve the water-dispersibility, this is not ensured and in any case is not long-lasting (see examples B and D). Replacing the short-chain unit (PA 66) with a longer-chain unit (PA 11) is not satisfactory either (see example D).

The study reveals, on the other hand, that the copolyamides according to the invention, including additional predominantly aliphatic polyamide units and a sufficient sulfonate monomer content, have excellent water-dispersibility in tap water at 70° C., even after conditioning for 15 days (examples 1 to 3). These copolyamides moreover have a suitable glass transition temperature and a suitable melt viscosity, and are thus excellent candidates as support materials for 3D printing.

1. A water-dispersible copolyamide comprising at least four different polyamide units, in which:
at least one of said polyamide units includes at least one sulfonate group, said polyamide sulfonate unit being present in a content of at least 15% by weight; and
at least two of said polyamide units are derived from aliphatic monomers;
it being understood that said copolyamide does not include more than 20% by weight of caprolactam-based unit, that it has a glass transition temperature of between 10° and 140° C. as measured by DSC according to the standard NF EN ISO 11 357-2 with a heating rate of 20° C./minute, and an inherent viscosity of greater than 0.4 dl/g as measured by applying the standard ISO 307:2007, but at 20° C. in a solution at 0.5% by weight in m-cresol.

2. The water-dispersible copolyamide as claimed in claim 1, comprising at least five different polyamide units.

3. The water-dispersible copolyamide as claimed in claim 2,
in which the copolyamide is of formula (I): 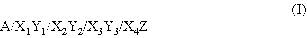
in which:
A is a unit obtained from at least one lactam or aminocarboxylic acid comprising at least 6 carbon atoms;
X₁Y₁ is a unit obtained from an aliphatic, cycloaliphatic, heterocyclic or arylaliphatic diamine X₁ and from an aliphatic or aromatic dicarboxylic acid Y₁;
X₂Y₂ is a unit obtained from an aliphatic, cycloaliphatic, heterocyclic or arylaliphatic diamine X₂ and from an aliphatic or aromatic dicarboxylic acid Y₂;
X₃Y₃ is a unit obtained from an aliphatic, cycloaliphatic, heterocyclic or arylaliphatic diamine X₃ and from an aliphatic or aromatic dicarboxylic acid Y₃; and
X₄Z is a unit obtained from an aliphatic, cycloaliphatic, heterocyclic or arylaliphatic diamine X₄ including 4 to 12 carbon atoms and a sulfonate compound Z chosen from aromatic dicarboxylic acid sulfonates, aliphatic sulfonates or esters thereof, including 4 to 18 carbon atoms and bearing at least one group of formula SO₃⁻X⁺in which X may be a hydrogen, a quaternary ammonium group or a monovalent metal.

4. The copolyamide as claimed in claim 1, not including more than 10% by weight of cycloaliphatic diamine residues.

5. The water-dispersible copolyamide as claimed in claim 3, in which A is a lactam or an aminocarboxylic acid including 10 to 12 carbon atoms, respectively, notably chosen from 11-aminoundecanoic acid and lauryllactam.

6. The water-dispersible copolyamide as claimed in claim 3, in which X₁, X₂, X₃ and X₄ are identical or different, and chosen from 1,2-ethylenediamine, 1,6-hexamethylenediamine, 1,9-nonanediamine and 1,10-decanediamine.

7. The water-dispersible copolyamide as claimed in claim 3, in which Y₁ and Y₂ are identical or different, and chosen from adipic acid, azelaic acid, sebacic acid and dodecanedioic acid.

8. The water-dispersible copolyamide as claimed in claim 3, in which Y₃ is isophthalic acid.

9. The water-dispersible copolyamide as claimed in claim 1, in which the sulfonate compound is chosen from the sodium, lithium or potassium salt of 5-sulfoisophthalic acid and the sodium, lithium or potassium salt of the methyl diester of 5-sulfoisophthalic acid.

10. The water-dispersible copolyamide as claimed in claim 3, comprising 0 to 30% by weight of unit A, 0 to 30% by weight of unit X₁Y₁, 0 to 30% by weight of unit X₂Y₂, 0 to 30% by weight of unit X₃Y₃ and 15% to 70% by weight of unit X₄Z, it being understood that said copolyamide includes at least four different polyamide units.

11. The water-dispersible copolyamide as claimed in claim 1, comprising at least 40% by weight of aromatic units.

12. The water-dispersible copolyamide as claimed in claim 1, having a glass transition temperature of between 11° and 130° C.

13. The water-dispersible copolyamide as claimed in claim 1, having an inherent viscosity of greater than 0.5 dl/g.

14. A process for manufacturing a water-dispersible copolyamide as claimed in claim 1, comprising the steps of:
a. providing monomers chosen, respectively, from a lactam, an aminocarboxylic acid, and a diamine and a diacid, in suitable number and proportions;
b. polycondensation of the monomers, where appropriate, in the presence of one or more catalysts and/or chain limiters under conditions suitable for obtaining said copolyamide; and
c. where appropriate, granulation of said copolyamide.

15. A composition comprising the water-dispersible copolyamide as claimed in claim 1, which is notably in filament form.
